(19) United States
(12) Patent Application Publication
(10) Pub. No.: US 2020/0223092 A1
(43) Pub. Date: Jul. 16, 2020

(54) Apparatus and Cassette for Supplying a Material to be Formed to a Plant for Producing Slabs

(71) Applicant: CEMENTHAI CERAMICS CO., Ltd., BANGKOK (TH)

(72) Inventors: Thanawat KRAINITHISOM, BANGKOK (TH); Thitipong MUANGSRI, BANGKOK (TH); Watthanakun PHABUTTA, BANGKOK (TH); Terdwong JAMRUSSAMEE, BANGKOK (TH)

(21) Appl. No.: 16/474,847

(22) PCT Filed: Dec. 28, 2017
(86) PCT No.: PCT/IB2017/058453

§ 371 Date: Jun. 28, 2019

(30) Foreign Application Priority Data
Dec. 29, 2016 (IT) 102016000132481

(51) Int. Cl. B28B 1/00; B28B 13/02

(52) U.S. Cl. CPC B28B 1/005; B28B 13/022

(57) ABSTRACT

An apparatus for supplying material to a plant for producing slabs. The apparatus comprises means for supplying the material to be formed, first collecting and moving means, a conveyor cassette and second collecting and moving means. The means for supplying the material take the material from reservoirs and deposit it on the first collecting and moving means to form a semi-finished mat. The first collecting and moving means provide a stable base for the material and move the semi-finished mat towards the conveyor cassette, which receives the semi-finished mat and deposits a uniform pad on the second collecting and moving means. The second collecting and moving means provide a stable base for the uniform pad and move it towards successive stations in the plant. The conveyor cassette comprises at least one flap adapted to cross the entire thickness of the flow of material which, goes through the conveyor cassette.

The present invention relates to an apparatus for supplying a material to be formed to a plant for producing slabs.

Procedures are known within the scope of producing construction materials, which, starting from a material to be formed, allow planar elements to be obtained, such as tiles, roof tiles, panels or, more generally, elements for the flooring, coating or covering of constructions. Hereinafter, all of these elements will be called slabs, as a whole, without limitation.

Below, for presentation purposes and without limitation, the material to be formed will be called “powder/powders”. Such term shall thus be understood to mean powder as such, in its dried form, but also any other material suitable for forming slabs, such as, for example slip, or rather a mixture or suspension obtained from at least one powder and at least one liquid.

Slabs are produced by special known plants, whose basic characteristics are described below. The plant usually comprises means for supplying the powders, which take the powders from special reservoirs and supply them to collecting and moving means, for example, to a conveyor belt. The powders deposited on the collecting and moving means are then compacted and sent for firing.

In such scope, during the production of a single slab, the need is felt to use powders, which differ in color, granulometry, appearance and/or composition. It is thus possible to produce slabs, which, when finished, comprise a predefined decoration. Such decoration is not, therefore, applied to the slab, but incorporated into the material itself. For example, decorations which are particularly appreciated include those which reproduce the appearance of natural stone.

The procedure is known for constituting the body of the slab with a plurality of premixed powders. A finer mixture can mimic natural stone with a finer grain, while a rougher mixture can reproduce natural stone with a larger grain. The depositing of a strip of different colored powder on the outer surface of the slab is also known, in order to reproduce veining of the natural stone. Despite being greatly appreciated, this procedure has the limit of producing a slab in which the veining is limited to the surface, while any cross section of the slab shows that the body of the thickness is uniform, without veining. No matter how effectively the overall appearance of the slab can mimic natural stone, the fact that the veining is only superficial immediately shows that the slab is artificial.

Equipment has been developed to overcome this drawback, to allow a selective supply of the powders, so that decorations can be made from the very depositing of the mixtures, involving the whole thickness of the slab. In order to reproduce natural stone, such equipment usually introduces means for randomly dispersing or distributing the powders. In this way, the artificial juxtaposition of accumulations of different powders is avoided. Despite being widely appreciated, this further solution is also not without defects. In fact, the inclusion of the random dispersion means indicates that it is impossible to control the effective arrangement of the powders in the finished slab a priori. In other words, in terms of reproducing natural stone, this equipment does not allow one same design to be reproduced twice. More generally, however, should the intention not be to reproduce natural stone, but another type of decoration is desired, the random dispersion machines do not allow the final appearance of the slab to be controlled a priori.

It is an object of the present invention to overcome, at least in part, the drawbacks described above in relation to the prior art.

In particular, it is a task of the present invention to provide equipment for depositing powders, which allows the final appearance of the slab to be controlled a priori.

Furthermore, it is a task of the present invention to provide equipment for depositing powders, which allows veining to be created, extending for the whole thickness of the slab.

The object and tasks evidenced above are achieved by means of an apparatus according to claim 1. Such apparatus will be described in further detail below, by way of a non-limiting example, with particular reference to the accompanying figures, wherein:

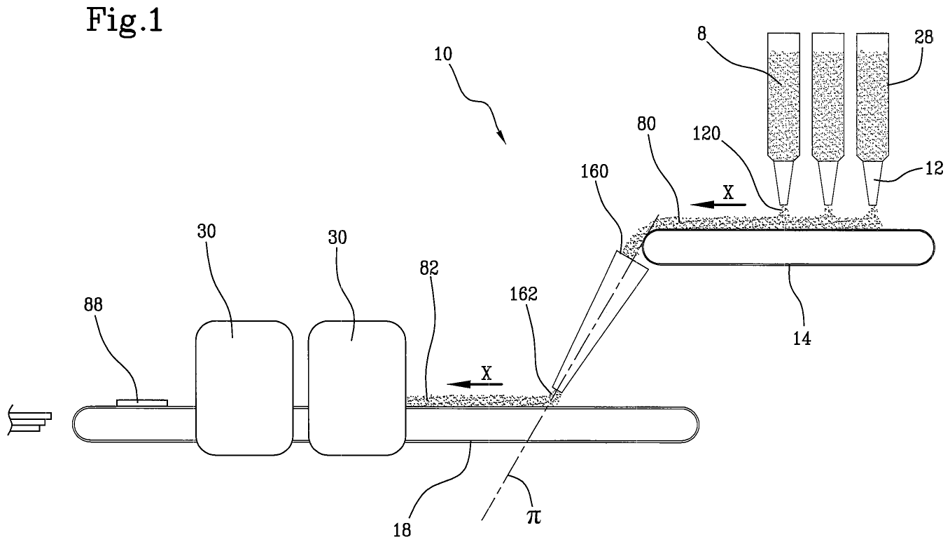

FIG. 1 schematically shows a side view of a plant for producing slabs;

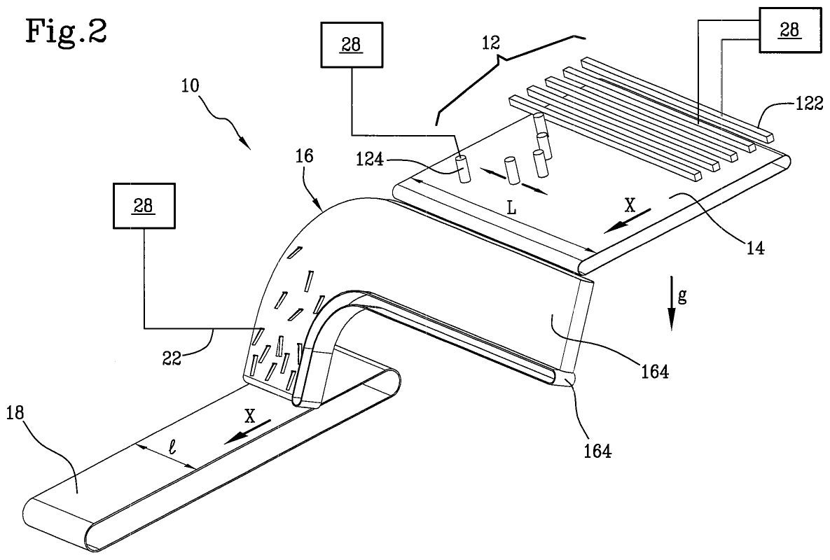

FIG. 2 schematically shows a perspective view of a first embodiment of an apparatus according to the invention;

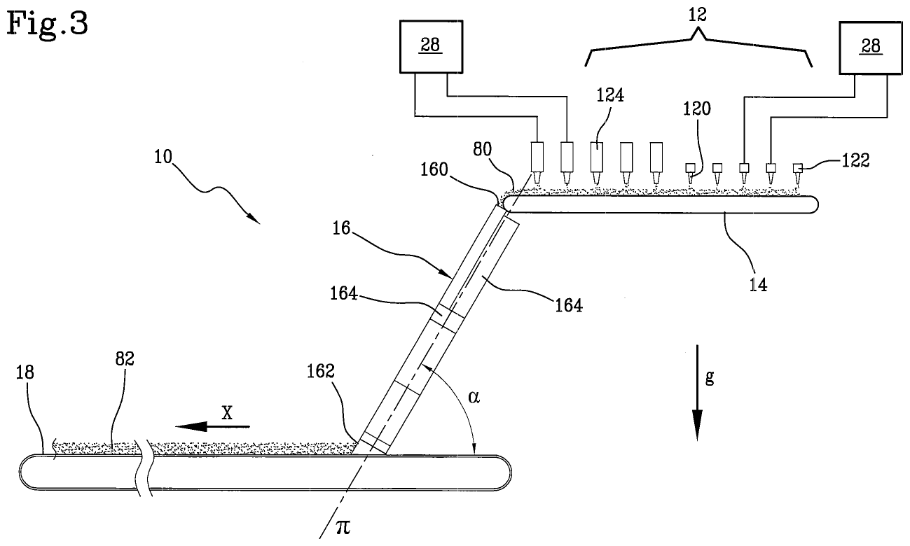

FIG. 3 schematically shows a side view of the apparatus in FIG. 2;

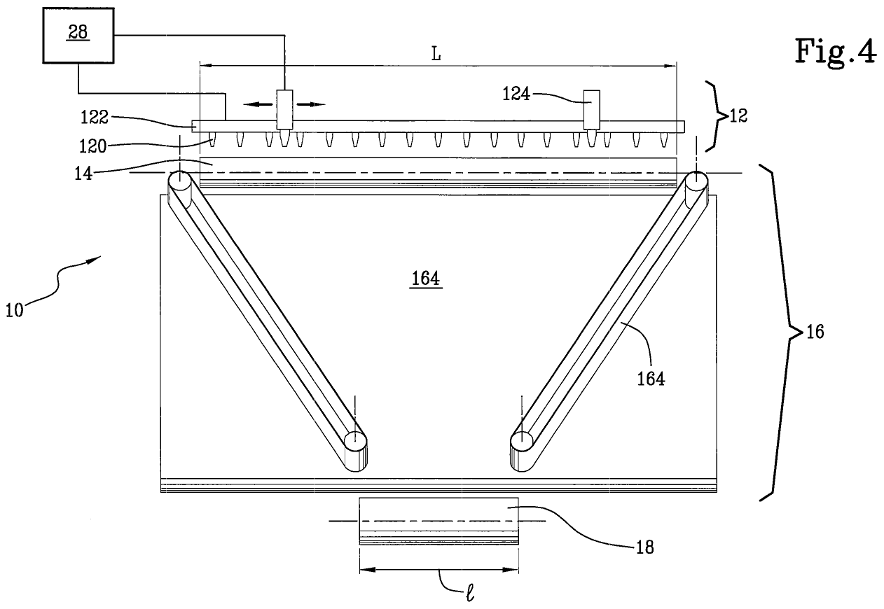

FIG. 4 schematically shows a front view of a second embodiment of the apparatus according to the invention;

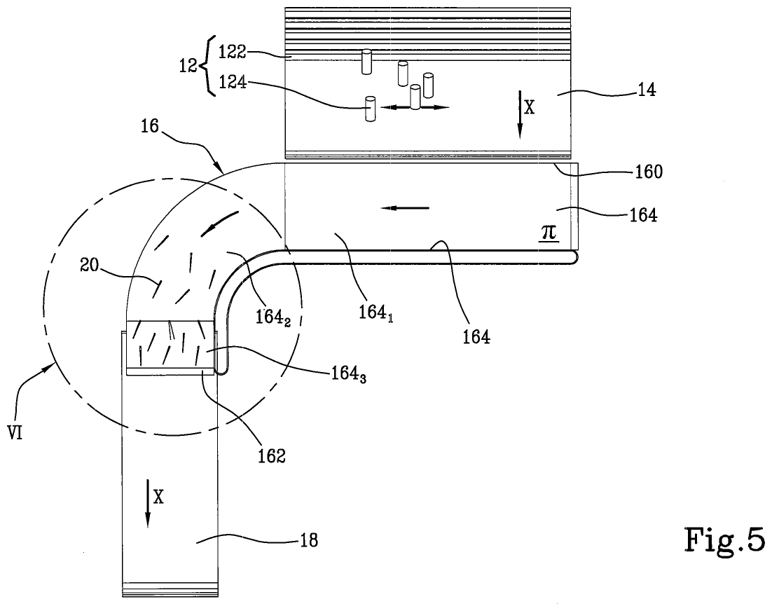

FIG. 5 shows another view of the apparatus in FIG. 2;

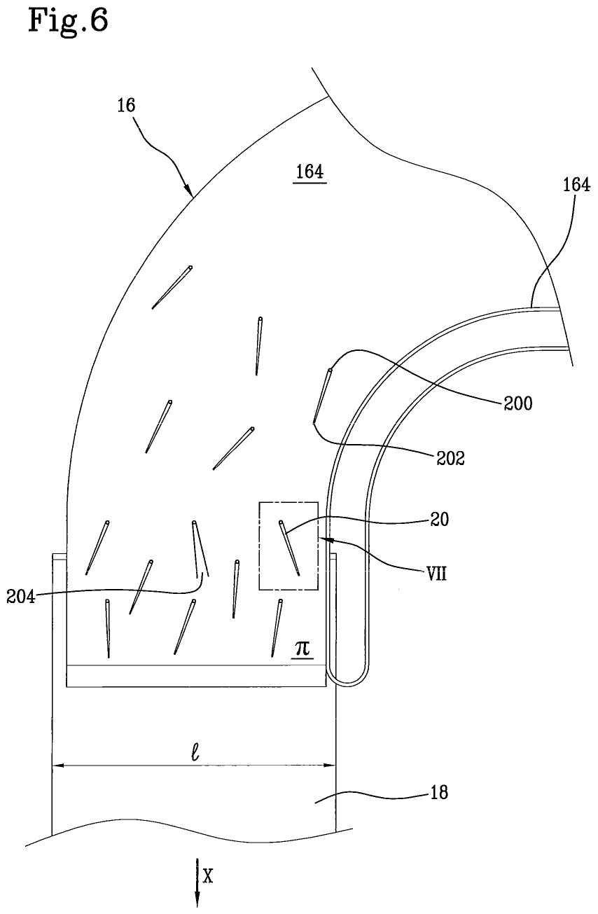

FIG. 6 shows an enlarged view of the detail indicated with VI in FIG. 5; and

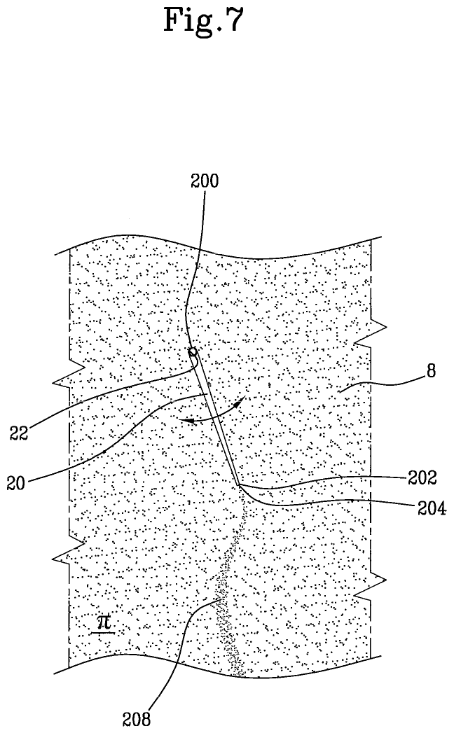

FIG. 7 shows an enlarged view of the detail indicated with VII in FIG. 6;

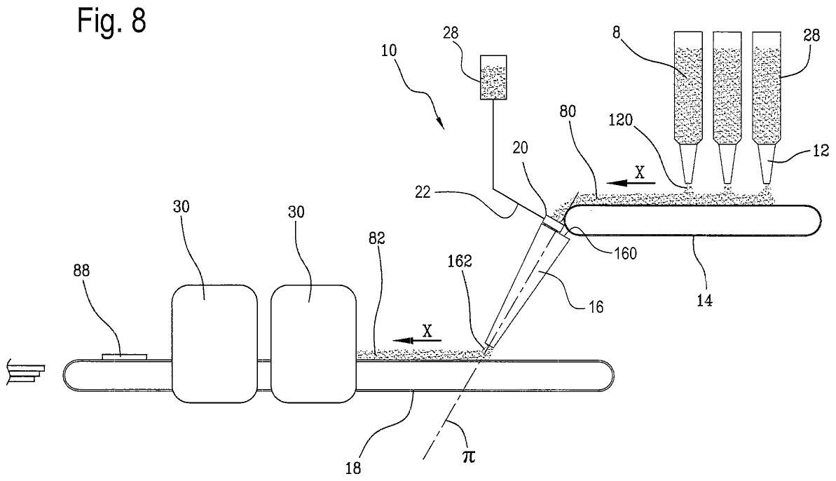

FIG. 8 schematically shows a side view of a third embodiment of an apparatus according to the invention; and

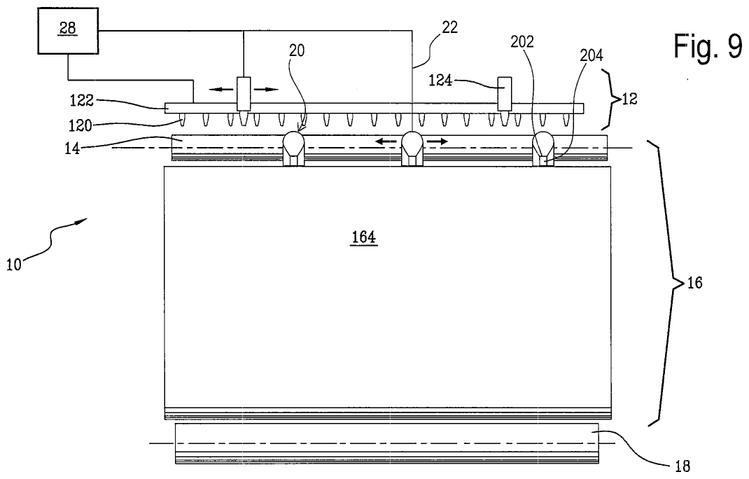

FIG. 9 schematically shows a front view of an embodiment similar to the one in FIG. 8.

The apparatus according to the invention is globally indicated below with 10. It comprises powder supplying means 12, first collecting and moving means 14, a conveyor cassette 16 and second collecting and moving means 18.

The powder supplying means 12, known per se, are adapted to take the powders 8 from special reservoirs 28 and deposit them in a controlled manner on the first collecting and moving means 14. The powders 8, deposited by the means 12, thus form a semi-finished mat 80, which is then supplied to the conveyor cassette 16.

Advantageously, the supplying means 12 for the powders 8 can be adapted to manage powders with different colors, granulometries, appearance and/or composition. Preferably, such means 12 comprise a plurality of nozzles 120 adapted to release the powders in a controlled manner. The nozzles, known per se, can be arranged in rows 122 and they can preferably be controlled individually to release the powders 8.

According to some embodiments, the nozzles 120 are arranged in a plurality of rows 122, so that every row can manage the supply of a single type of powder. As a whole, the rows 122 can thus manage the supply of a plurality of different powders 8 and in this way they can form a mat 80 according to a predefined scheme. The scheme must be defined on the basis of the decoration, which is to appear on the finished slab 88.

According to other embodiments, the powder supply means 12 comprise one or more translating nozzles 124. Such nozzles are adapted to be moved transversely with respect to the advancing direction X of the first collecting and moving means 14; in this regard, see FIGS. 2, 4 and 5. In this way, with a specific type of powder, it is possible to obtain one or more continuous lines, which can potentially cross the whole of the width of the semi-finished mat 80, according to a predefined scheme.

The embodiment of the apparatus shown in FIG. 2 comprises both a plurality of rows 122 of nozzles 120 and a plurality of translating nozzles 124. This particularly complete configuration allows great freedom in the composition of the semi-finished mat 80 of powders 8.

The first collecting and moving means 14 are adapted to provide a stable base for collecting the powders 8 deposited by the powder supply means 12. Furthermore, the first collecting and moving means 14 are adapted to move the semi-finished mat 80, which is gradually formed by the depositing of the powders 8, towards the conveyor cassette 16. The first collecting and moving means 14 typically comprise a conveyor belt and they will be identified as such hereafter to simplify presentation; note, however, that such presentation choice is without limitation and the first collecting and moving means can be made in any other way known to an expert. In the example in FIG. 2, the conveyor belt has a width L and can therefore manage a semi-finished mat 80 with a width equal to or smaller than L.

The conveyor cassette 16 is placed downstream of the first conveyor belt 14. Such device is adapted to receive the semi-finished mat 80 of powders 8 from the first conveyor belt 14, and it is adapted to deposit a uniform pad 82 of powders 8 on the second collecting and moving means 18, which will be sent for further processing. The conveyor cassette 16 is also adapted to harmonize the distribution of the powders, so that, unlike the semi-finished mat 80, the uniform pad 82 has a constant thickness.

The second collecting and moving means 18 are placed downstream of the conveyor cassette 16, which can, for example, comprise a conveyor belt (see the examples in the appended figures). As above, to simplify presentation, the second collecting and moving means 18 will also be identified hereafter with a conveyor belt, without limitation. In fact, in addition to and/or as an alternative to the conveyor belt, the second collecting and moving means 18 can also comprise dies for the molding of the slabs, such as, for example, trays or grids. The second conveyor belt 18 is adapted to provide a stable base for collecting the uniform pad 82 deposited by the conveyor cassette 16. In the example in FIG. 2, the second conveyor belt 18 has a width I and can therefore manage a uniform pad 82 with a width equal to or smaller than I. Finally, the second conveyor belt 18 is adapted to move the uniform pad 82 towards the successive stations (indicated schematically with 30 in FIGS. 1 and 8) where the steps of compacting, cutting, molding and firing the slabs 88 are carried out.

According to one aspect of the invention, the walls of the conveyor cassette 16 which, in use, are intended to support, at least in part, the weight of the powders 8 introduced, comprise active surfaces 164. In some embodiments, the conveyor cassette 16 mainly develops in a plane π, which is substantially perpendicular with respect to the plane of the second conveyor belt 18. With respect to the plane of the second conveyor belt 18, the plane π of the conveyor cassette 16 forms an angle α preferably greater than or equal to 80° and smaller than 90°, even more preferably comprised between 85° and 89°.

As can be seen in the example in FIG. 3, the conveyor cassette 16 mainly develops in a plane π, which is preferably inclined with respect to the plane of the second conveyor belt 18. With respect to the plane of the second conveyor belt 18, the plane π of the conveyor cassette 16 forms an angle α preferably greater than or equal to 30° and smaller than 90°, even more preferably comprised between 45° and 80°. Such inclination allows the powders to flow easily through the conveyor cassette 16, without creating unwanted obstructions or accumulations and without causing a true free fall.

Furthermore, according to some embodiments, the conveyor cassette 16 comprises an inlet port 160 and an outlet port 162, wherein the inlet port 160 has a larger width than the outlet port 162. According to the embodiments of the conveyor cassette 16 shown in the appended FIGS. 2 and 4, the outlet port 162 has a width equal to, or smaller than the width I of the second conveyor belt 18. Furthermore, according to such embodiments shown by way of example, the inlet port 160 has a width equal to, or greater than the width L of the first conveyor belt 14. These dimensions of the inlet and outlet ports allow the conveyor cassette 16 to collect the powders 8 supplied by the first conveyor belt 14 easily and deposit such powders 8 on the second conveyor belt 18 just as easily.

As stated above, the walls of the conveyor cassette 16, which, in use, are intended to support, at least in part, the weight of the powders 8, comprise active surfaces 164. In other words, the vector g of the gravity acceleration (shown in the appended figures) will have a well-defined orientation with respect to the apparatus 10 once this has been assembled correctly, in working order. According to the invention, the walls of the conveyor cassette 16 comprise active surfaces 164, which are crossed by the vector g with any angle. More specifically, the walls of the conveyor cassette 16 comprise active surfaces 164 with respect to which the vector g has a non-null perpendicular component.

The active surfaces 164 can comprise conveyor belts, as in the examples shown in the appended figures. The presence of the active surfaces 164 allows, for example, a speed to be imposed on the walls of the conveyor cassette 16, which is equal to the flow velocity of the powders 8. In this way, the active surfaces 164 can accompany the powders during their flow through the conveyor cassette 16 thus preventing the walls from introducing friction phenomena with the powders 8. In conveyor cassettes of the known type with fixed walls, these friction phenomena occur and introduce a speed gradient into the mass of powders. More particularly, the powders flow with a reduced speed as they gradually approach the fixed wall. These different speeds of the different layers of powder introduce an a priori uncontrollable distortion into the distribution of the powders. In this way, a random factor is introduced into the formation of the uniform pad 82, making it thus impossible to control the effective distribution of the powders in the uniform pad 82 and, consequently, in the finished slabs. On the contrary, in the conveyor cassette 16 according to the invention, such speed gradient is avoided and the powders can flow without any distortion in the distribution, thus allowing the effective distribution of the powders to be controlled in the uniform pad 82 and, consequently, in the finished slabs 88.

Note that, in general, the distribution of the powders in the uniform pad 82 will not be the same as in the semi-finished mat 80 because the conveyor cassette 16 can introduce a redistribution of the powders. However, such redistribution of the powders is not random, but it is carried out according to known and foreseeable methods, which is why it is possible to control the final appearance of the slab.

According to some embodiments, the conveyor cassette 16 has, as a whole, a trapezoidal shape. The walls which, in use, withstand, at least in part, the weight of the powders 8, are the bottom wall (lying on the plane π) and at least one of the side walls (perpendicular to the plane π). In the particular example in FIG. 4, both of the side walls, inclined between each other and perpendicular to the plane π, withstand, at least in part, the weight of the powders 8. Such walls comprise active surfaces 164 according to the invention.

According to other embodiments, shown schematically in FIGS. 2 and 5, the conveyor cassette 16 has a more complex shape, which can be defined, as a whole, as angled. In a first rectilinear portion of the conveyor cassette 16, a flow is imposed on the powders which, despite being comprised in the plane π, is transverse with respect to the advancing direction X of the first conveyor belt 14. Such portion is followed by a curve, still comprised in the plane π, which aligns the flow of the powders with the advancing direction of the second conveyor belt 18. In the embodiments considered herein, the advancing direction X of the first conveyor belt 14 coincides with the advancing direction of the second conveyor belt 18, even though such feature is not strictly necessary.

The walls of the conveyor cassette 16 which, in use, withstand, at least in part, the weight of the powders 8, are the bottom wall (lying in the plane π), the lower straight wall (perpendicular to the plane π) and the convex wall, which defines the inside of the curve (also perpendicular to the plane π). According to the invention, such walls comprise active surfaces 164.

As can be seen from FIG. 5, in this particular embodiment, the bottom wall of the first portion of the conveyor cassette 16 comprises an active surface 1641, which imposes on the powders 8 the flow in a transverse direction, in particular in a perpendicular direction, with respect to the advancing direction X of the first conveyor belt 14. Such transverse active surface is followed by a curved active surface 1642, which, keeping the flow in the plane π, changes its orientation until it is aligned with the advancing direction X of the second conveyor belt 18. The curved active surface 1642 can be followed, in turn, by a further active rectilinear surface portion 1643, already aligned with the second conveyor belt 18.

According to one aspect of the invention, the conveyor cassette 16, which mainly develops in a plane π, comprises at last one flap 20 perpendicular to the plane π.

According to some embodiments, the flap 20 is adapted to cross the entire thickness of the flow of powders 8, which, in use, goes through the conveyor cassette 16.

According to other embodiments of the invention, the flap 20 is at least partially orientable with respect to the flow of the powders, which surrounds it. As an expert can easily understand, the reference to the flow of powders, made in the present document, refers to the apparatus 10 in the state of use.

The section of the flap 20 is preferably defined so as to minimize its effect on the flow of the powders 8. In this respect, it is possible, for example, to draw on the experience of fluid dynamics and give the flap 20 a spindle-like profile, for example a typical airfoil. It is possible to define a leading profile 200 on each of the flaps 20, which is first hit by the flow of the powders, and a trailing profile 202, from which the flow of the powders separates. Keeping the fluid dynamics analogy, we can say that the flap 20 can vary the angle of attack with respect to the flow of the powders. See FIG. 7 in this regard. In this way, it is possible to redefine the distribution of the powders 8, which flow through the conveyor cassette 16, defining the uniform pad 82, in a controlled manner.

According to some embodiments, the at least one flap 20 is hollow and it is adapted to take powders 8 from a special remote reservoir 28 and release them into the flow of powder surrounding it, so as to form a vein 208. The trailing profile 202 preferably comprises a slot 204, which extends perpendicularly to the plane π for the entire height of the flap 20, so that the vein 208 crosses the entire thickness of the flow of the powders 8. Advantageously, the powders 8 reach the flap 20 along a conduit 22, which, at least in its final section, has a perpendicular development to the plane π. Inside the flap 20, the powders are deflected and then released into the direction, which is locally defined by the flow in proximity to the trailing edge 202. In this way, by releasing powders from the flap 20 and varying the incidence of the latter, it is possible to create a vein 208 with a desired predefined development, for example a sinuous development. The conduit 22, which supplies the powders to the flap 20, preferably also defines the axis and/or command for the rotation of the latter, so as to vary its incidence with respect to the flow of the powders.

According to another possible embodiment of the invention, the slot 204 positioned on the trailing edge 202 of the flap 20 can have an adjustable width. In this way, the thickness of the vein 208 formed by the flap 20 can be adjusted and varied.

According to other embodiments, the flaps 20 are arranged on the conveyor cassette 16 in proximity to the inlet port 160, immediately upstream thereof. In other words, the flaps 20 are arranged between the first collecting and moving means 14 and the conveyor cassette 16. Also in such embodiments, the flaps 20 can have one or more of the technical characteristics described above. Furthermore, in these embodiments schematized in FIGS. 8 and 9, the flaps 20 can preferably be moved transversely with respect to the advancing direction X of the first collecting and moving means 14; see FIGS. 8 and 9 in this regard. In this way, with a specific type of powder, it is possible to obtain one or more continuous lines, which can potentially cross the whole of the width and thickness of the semi-finished mat 80, according to a predefined scheme.

The embodiments of the invention have been described by way of a non-limiting example. The technical features described by way of example relating to one embodiment can also be adopted for other embodiments. In order to satisfy specific needs, an expert can modify various characteristics or replace various elements with other technically equivalent elements, without going beyond the scope of the appended claims.

1. Apparatus (10) for supplying a material to be formed (8), such as powder and/or slip, to a plant for producing slabs (88), comprising means (12) for supplying the material to be formed (8), first collecting and moving 5 means (14), a conveyor cassette (16) and second collecting and moving means (18), wherein:
the means (12) for supplying the material to be formed are adapted to take the material to be formed (8) from reservoirs (28) and deposit it in a controlled manner on the first collecting and moving means (14) so as to form a semi-finished mat (80) of material to be formed (8);
the first collecting and moving means (14) are adapted to provide a stable base for collecting the material to be formed (8) deposited by the supplying means (12) and to move the semi-finished mat (80) of material to be formed (8) towards the conveyor cassette (16);
the conveyor cassette (16) is adapted to receive the semi-finished mat (80) of material to be formed (8) from the first collecting and moving means (14), and it is adapted to deposit a uniform pad (82) of material to be formed (8) on the second collecting and moving means (18);
the second collecting and moving means (18) are adapted to provide a stable base for collecting the uniform pad (82) deposited by the conveyor cassette (16) and to move the uniform pad (82) towards successive stations in the plant;
characterized in that the conveyor cassette (16) comprises at least one flap (20) adapted to cross the entire thickness of the flow of material to be formed (8) which, in use, goes through the conveyor cassette (16).

2. Apparatus (10) according to claim 1, wherein the conveyor cassette (16) mainly develops in a plane π and wherein the flap (20) is perpendicular to the plane π.

3. Apparatus (10) according to claim 1, wherein the flap (20) is arranged on the conveyor cassette (16) in proximity to an inlet port (160), immediately upstream thereof.

4. Apparatus (10) according to claim 1, wherein the flap (20) is at least partially orientable with respect to the flow of material to be formed (8).

5. Apparatus (10) according to claim 1, wherein the flap (20) is hollow and it is adapted to take material to be formed (8) from a reservoir (28) and to release the material to be formed (8) into the flow of material to be formed, which surrounds it, so as to form a vein (208).

6. Apparatus (10) according to claim 5, wherein the flap (20) comprises a slot (204), which extends perpendicularly to the plane π for the entire height of the flap (20), so that the vein (208) crosses the entire thickness of the flow of material to be formed (8).

7. Apparatus (10) according to claim 5, wherein the flap (20) comprises a conduit {22) for supplying the material to be formed (8), such conduit (22) being perpendicular, at least in its final portion, to the plane π, and wherein the conduit (22) also defines the axis for the rotation of the flap (20).

8. Apparatus (10) according to claim 6, wherein the slot (204) of the flap (20) has an adjustable width.

9. Apparatus (10) according to claim 1, wherein the walls of the conveyor cassette (16) which, in use, are intended to support, at least in part, the weight of the material to be formed (8), comprise active surfaces (164).

10. Apparatus (10) according to claim 9, wherein the conveyor cassette (16) mainly develops in a plane π substantially perpendicular with respect to the plane of the second collecting and moving means (18) and wherein the plane π of the conveyor cassette (16) forms, with respect to the plane of the second collecting and moving means (18), an angle α preferably larger than, or equal to 80° and smaller than 90°, even more preferably comprised between 85° and 89°.

11. Apparatus (10) according to claim 9, wherein the conveyor cassette (16) mainly develops in a plane π, which is inclined with respect to the plane of the second collecting and moving means (18) and wherein the plane π of the conveyor cassette (16) forms, with respect to the plane of the second collecting and moving means (18), an angle α larger than, or 5 equal to 30° and smaller than 90°, preferably comprised between 45° and 80°.

12. Apparatus (10) according to claim 9, wherein the active surfaces (164) comprise conveyor belts.

13. Apparatus (10) according to claim 1, wherein the flap (20) is adapted to be moved transversely with respect to an advancing direction X of the first collecting and moving means (14).
